(19) United States
(12) Patent Application Publication
(10) Pub. No.: US 2025/0236751 A1
(43) Pub. Date: Jul. 24, 2025

(54) A SET OF INK FOR INKJET PRINTING A PLASTIC SUBSTRATE FOR BEING USED IN THE MANUFACTURING OF DECORATIVE PANELS, A METHOD FOR PRINTING ON A PLASTIC SUBSTRATE, A PRINTED PLASTIC SUBSTRATE AND A DECORATIVE PANEL

(71) Applicant: Unilin, BV, Wielsbeke (BE)

(72) Inventor: Benjamin CLEMENT, Waregem (BE)

(73) Assignee: Unilin, BV, Wielsbeke (BE)

(21) Appl. No.: 18/700,961

(22) PCT Filed: Oct. 6, 2022
(86) PCT No.: PCT/IB2022/059528

§ 371 Date: Apr. 12, 2024

Related U.S. Application Data
(60) Provisional application No. 63/255,611, filed on Oct. 14, 2021.

(51) Int. Cl. C09D 11/40; B41M 3/06; B41M 5/00; B44C 5/04; B44F 9/02; B44F 9/04; C08J 7/04; C09D 11/037; C09D 11/322; C09D 11/324; C09D 11/54

(52) U.S. Cl. CPC C09D 11/40; B41M 3/06; B41M 5/0017; B41M 5/0047; B41M 5/0064; B44C 5/04; C08J 7/042; C09D 11/037; C09D 11/322; C09D 11/324; C09D 11/54; B44F 9/02; B44F 9/04

(57) ABSTRACT

A set of inks for inkjet printing on a plastic substrate for being used in a laminated panel may be pigmented inks. The set of inks may include a cyan ink, a yellow ink, a red ink, and a black ink.

This application claims priority under 35 USC § 119(e) from U.S. Provisional Patent Application No. 63/255,611 filed Oct. 14, 2021, the entire contents of which are incorporated herein by reference.

### BACKGROUND

### 1. Field

The present invention relates to a set of ink for inkjet printing a plastic substrate for being used in the manufacturing of decorative panels, for example floor, wall or furniture panels, preferably said substrate being a plastic foil or a plastic panel. The invention may further relate to a method for printing on a plastic substrate, a printed plastic substrate an/or to a decorative panel.

### 2. Related Art

Plastic foils for decorative panels are usually printed using analogue gravure printing. In analog gravure printing multiple inks are printed using multiple engraved rollers, each roller being dedicated do a specific ink and to a specific design. Therefore, for each design to be printed it is possible to select the specific composition of each ink that best suit that specific design. A known drawback of analog printing is that shifting from one design to another is expensive and time consuming since it is necessary to engrave new cylinders and formulate the inks.

Decorative panels based on plastic (or polymeric) material usually have a décor imitating a wood, stone, ceramic and/or cement décor. During private research the inventors have found that in analogue rotogravure printing of wood design, it is preferable to use red and yellow pigments that have warm tonality, for example of red and orange; whereas for printing of stone imitating design it is preferable to use red and yellow color with a colder tonality, for example a blueish tonality.

Digital inkjet printing normally provides for a higher flexibility of the printing process and simplifies the operation of shifting from a décor to another one.

Thereto, in order to easily and quickly shift from one décor to another, the set of inks used in inkjet printing of plastic foils for decorative panel comprises ink of the primary colors, cyan, magenta and yellow, and black. This set of colors in fact provides for a broad color gamut that makes possible to print almost any desired design. Examples of magenta and yellow pigments are CI magenta pigment 122, CI yellow pigments 74, yellow pigments 155, yellow pigments 151.

Since the color build up is different in analog printing and inkjet printing, the switching from analog to digital printing can lead to metamerism issues. Moreover, the inventors, during private research have found that in order to correct said metamerism effect, it may be necessary to increase the ink load in order to correct the shades of the starting pigments. The inventors have also found that when said printed polymeric substrate as to be laminated to a wear layer, as in the manufacturing of floor panels, an excess of ink load and in particular of pigment load on the printed substrate may lead to adhesion issues between the printed substrate and the wear layer.

### SUMMARY

The present invention aims in the first place to provide an alternative ink set for inkjet printing onto plastic substrate for decorative panels, which, in accordance with several of its preferred embodiments, is directed to solve one or more of the problems arising in the state of the art.

Thereto, the present invention, according to its first independent aspect, a set of inks for inkjet printing on plastic substrate, for example a plastic panel or a plastic foil for being used in laminated panel, preferably floor, wall or furniture panels.

Said inks being pigmented inks. Some or all of said pigments may comprise an average particle size measured in a dynamic light scattering device below 300 nm. In some embodiments, said inks may comprise a pigment load between 2 and 7% weight on the total weight of the ink.

Preferably said set of inks comprises: a cyan ink, a yellow ink, at least a red ink and at least a black ink. Said set of ink may be free of magenta ink.

In some embodiments said red ink can comprise pigment selected from the group consisting of: C.I. pigment red 144, C.I. pigment red 254, C.I. pigment red 176, C.I. pigment red 122, C.I. pigment red 202, C.I. pigment violet 19, C.I. pigment red 32 or a mixed crystal thereof. Said pigments provides for a reduced color gamut, but the inventor has surprisingly found that their implementation into an inkjet printer can lead to a reduced metamerism in the shifting of a wood or stone design from an analog printing to digital printing. Moreover, they provide for a reduced ink consumption leading to cost saving and improved adhesion after lamination with a wear layer.

In some embodiments said red ink can show a warm tonality, for example with orange and/or yellow shades. In some embodiment said red ink may comprise at least one pigment selected in the group consisting of: C.I. pigment red 144, C.I. pigment red 254, C.I. pigment red 176 or mixed crystal thereof. In some embodiment the red ink may comprise at least one red pigment having a HUE angle between 350° and 42°, for example said red ink may comprise a mixture of red pigments and wherein each of said pigments has a HUE angle between 350° and 42°. Said pigments have been found to be particularly adapted for limiting the color metamerism in the printing of wood decors.

In some embodiments said red ink can show a cold tonality, for example with violet and/or blue shades. For example, said red ink may comprise at least one pigment selected in the group consisting of: C.I. pigment red 122, C.I. pigment red 202, C.I. pigment violet 19, C.I. pigment red 32 or a mixed crystal thereof. In some embodiment, said red ink may comprise at least one red or violet pigment having a hue angle between 312° and 350°, said red ink may also comprise a mixture of pigments and wherein each of said pigments has a HUE angle between 312° and 350°. Said pigments have been found to be particularly adapted for limiting the color metamerism in the printing of stone or cement decors.

Preferably said set of ink may comprise a first red ink and a second red ink wherein said first and second red ink are different each other, for example they comprise different pigments. For example, said first red ink can have a warmer tonality and the second red ink can have a colder tonality. The inventor has found that using a set of ink having two different set of red inks leads to an enlarged color gamut with respect to a set of ink using a unique red ink. Therefore, in this way it may be possible to print an enlarged selection of decors, in particular wood and stone décor, with the same set of inks but with an improved quality, reduced metamerism and reduced ink consumption compared to CMYK color system.

In some embodiments said first red ink can comprise at least one pigment selected in the group consisting of: C.I. pigment red 144, C.I. pigment red 254, C.I. pigment red 176 or mixed crystal thereof; and/or said second red ink can comprise at least one pigment selected in the group consisting of: C.I. pigment red 122, C.I. pigment red 202, C.I. pigment violet 19, C.I. pigment red 32 or a mixed crystal thereof.

In some embodiments said first red ink may comprise at least one pigment having a hue angle between 350° and 42°, for example wherein said first red ink can comprise a mixture of pigments and wherein each of said pigments has a hue angle between 350° and 42°.

In some embodiments, said second red ink can comprise at least one pigment having a hue angle between 312° and 350°, for example wherein said second red ink can comprise a mixture of pigments and wherein each of said pigments has a hue angle between 312° and 350°.

In some embodiments, said yellow ink may comprise a pigment selected form selected in the group consisting of: C.I. pigment yellow 110, C.I. pigment yellow 150, C.I. pigment yellow 93, C.I. pigment yellow 139 or a mixed crystal thereof. Inventors have found that this kind of yellow pigments has a reduced greenish shade compared to yellow pigment conventionally used in inkjet printing and may lead to a reduced metamerism, and reduced ink consumption, especially for printing wood and stone décor, and in particular if used in combination with the preferred red inks according to the invention and indicated above.

In some embodiments, the cyan pigment can comprise a phthalocyanine pigment.

In some embodiments, said black pigment can comprise a carbon black pigment.

In some embodiments the set of inks may comprise a first and a second black ink, preferably said second black ink may have a lower color intensity than the first black ink. For example, said second black ink can comprise a pigment load lower than the first black ink, preferably said pigment load of the second black ink is at least 4, more preferably at least 5 times lower than the first black ink. In some embodiments, said first black ink may comprise a pigment load between 2 and 7% weight on the total weight of the ink. In some embodiments, said second black ink may comprise a pigment load comprised between 0.1 and 2% based on the total weight of the ink. The inventor has found that droplets of said second black ink can be print beside droplets of the first black ink to reduce unprinted white areas and reduce the grainy effect that is often obtained with a unique black ink. The color gamut may be further improved using the second black ink.

In some embodiments said inks of the set can be water-based, UV based or hydro-UV based.

In some embodiments the viscosity of the ink is below 15 mPas at temperatures between 25 and 45° C.

In some embodiments the water-based ink may comprise polymer resin in amount 1-20% dry resin content from resin dispersion, preferably a PUD resin, acrylic resin, styrene acrylic resin or combinations thereof. In some embodiment the water-based ink may comprise wetting agent in a content of 0.1-3%, preferably surfynol 104E. In some embodiment the water-based ink may comprise coalescing agent in a content of 0-6%, preferably Dowanol DPnP. In some embodiment the water-based ink may comprise cosolvent in an amount of 2-40%, preferably 1,2 propanediol. In some embodiment the water-based ink may comprise humectant in an amount of 2-40%, preferably 1,2 hexanediol. In some embodiment the water-based ink may comprise dispersant in an amount of 1-10%. In some embodiment the water-based ink may comprise a pH adjuster in an amount of 0.1-1%. In some embodiment the water-based ink may comprise water in an amount of 25-80%.

In some embodiments the UV-based ink may comprise dispersant in an amount of 1-6%, preferably Efka types. In some embodiments the UV-based ink may comprise (meth)acrylic Monomer 10-90%, preferably NVC, ACMO, DPGDA, VMOX, TMPTA, TPGDA. In some embodiments the UV-based ink may comprise polymer in an amount of 1-20%, for example polyester, urethane acrylate, polyester acrylate, polyether acrylate, epoxy acrylate or mixture thereof. In some embodiments the UV-based ink may comprise photo-initiator in an amount of 0.1-10%, for example TPO-L, Irgacure 184, Benzophenone. In some embodiments the UV-based ink may comprise stabilizer in an amount of 0.01-1%, for example irgastab UV10. In some embodiments the UV-based ink may comprise surfactant in an amount of 0.01-2%, for example Byk UV3510.

Another independent aspect of the invention provides for a method for manufacturing an inkjet printed plastic substrate using the ink set of the first independent aspect.

Thereto a second independent aspect of the invention relates to a method for manufacturing a printed plastic substrate, said substrate being of the type to be used in laminated panel, preferably floor, wall or furniture panels, comprising the step of providing said plastic substrate and the step of inkjet printing a décor on said plastic substrate, wherein said step of inkjet printing is performed using the set of inks according first independent aspect.

In some embodiments, especially when the inks are of the water-based type, an ink receiver layer may be provided on the surface of said substrate before printing the ink, said ink receiver layer can comprise a binder and a metal salt. In some embodiment said binder can preferably comprise water-based dispersion of terpolymer vinyl chloride, vinyl acetate ethylene; water-based dispersion or copolymer vinyl chloride, vinyl acetate; water-based aliphatic PU dispersion; other non-blocking water-based acrylics dispersions. The metal salt can comprise a cationic metal salt for example AlCl2. The inkjet receiving layer can further comprise a cross linker and/or other additives like dispersant, coupling agent, wetting agent or PH modifiers. In some embodiments said inkjet receiver layer can comprise a pigment, preferably mineral particles, adapted to adsorb the vehicle of the ink.

In some embodiments, especially when the inks are of the water-based type, a plasma or corona treatment may be performed on the surface to the substrate before printing the ink, especially in case the inks are of the UV-based types, or before providing said ink receiver layer.

In the preferred embodiment the plastic substrate can be a plastic foil. In some embodiments said substrate can be a plate shaped substrate, for example a rigid substrate, preferably a panel or a board.

In some embodiments said plastic substrate can be made of a thermoplastic material for example vinyl-based, polyolefins, or polyesters, preferably selected from the group consisting of: polyvinyl chloride (PVC), polyethylene (PE) and polypropylene (PP), polyamides (PA), polyurethane (PU), polystyrene (PS), acrylonitrile-butadiene-styrene (ABS), polymethyl methacrylate (PMMA), polycarbonate (PC), polyethylene terephthalate (PET), polyetheretherketone (PEEK) or mixtures or co-polymers thereof.

In some embodiment substrate can comprise an LVT, WPC or SPC panel or board. Said board can comprise a thermoplastic material of the type used for the foil and one or more fillers.

Preferably said décor can be a wood, stone, ceramic and/or cement imitating décor.

In some embodiments the method of the second aspect can comprise the step of drying and/or curing the printed inks, for example IR drying or UV curing.

A third aspect of the invention may relate to a printed plastic foil for being used in laminated panel, preferably floor, wall or furniture panels, wherein said printed foil comprises an inkjet printed décor that is printed using the set of inks of the first independent aspect.

A fourth independent aspect of the invention may relate to a method for manufacturing a panel, preferably floor, wall or furniture panels, comprising a substrate, preferably made of thermoplastic material, and a top layer, said top layer comprising a décor layer, wherein said décor layer is printed using the set of inks of the independent aspect. In some embodiments said décor layer can comprise a printed plastic foil or can be printed directly on top of said substrate. In case the décor layer is provided in a printed foil it can be laminated onto the substrate, for example by heat lamination or by gluing. Preferably said top layer may comprise a wear layer, for example wherein said wear layer is made of thermoplastic material. Said wear layer can be a transparent layer. Said wear layer can be provided on top of the decorative layer.

In some embodiment, before laminating said wear layer, an adhesion layer can be applied on said décor layer. In some embodiments, said adhesion layer can comprise water-based dispersion of terpolymer vinyl chloride, vinyl acetate ethylene; water-based dispersion or copolymer vinyl chloride, vinyl acetate; water-based aliphatic PU dispersion; other non-blocking water-based acrylics dispersions, thereby strongly improving lamination between the décor layer and the wear layer.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

With the intention of better showing the characteristics of the invention, in the following, as an example without any limitative character, several preferred forms of embodiments are described with reference to the accompanying drawings, wherein:

FIG. 1 shows a color wheel with the indication of the hue angles;

FIG. 2 shows a portion of a wood décor and two enlargements of a same detail of said wood décor that are printed using one black ink and two black inks respectively;

FIG. 3 shows two schematic distribution of printed dots using one black ink and two black inks respectively;

FIG. 4 shows in perspective a panel according to the invention;

FIG. 5 shows a view according to the line V-V indicated on FIG. 4;

FIG. 6 shows on a larger scale provide a view on the area F6 illustrated in FIG. 5;

FIG. 7 shows some steps in a method for forming the panel of FIG. 4; and

FIG. 8 shows some steps in an alternative method for forming the panel of FIG. 1.

### DESCRIPTION OF NON-LIMITING EMBODIMENTS

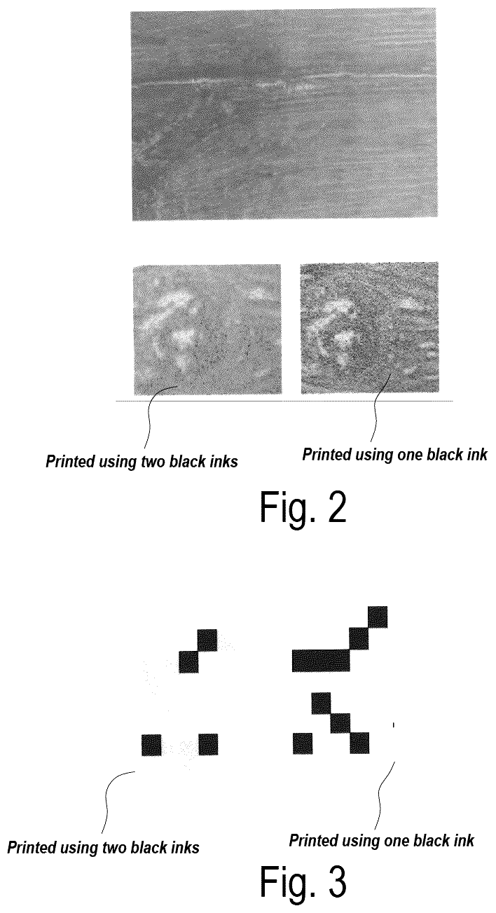

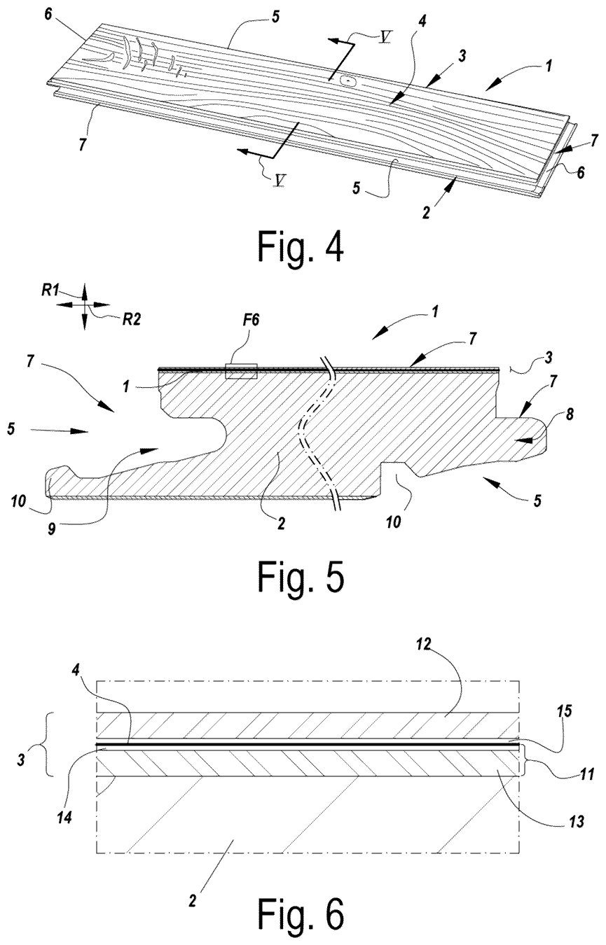

FIG. 4 illustrates a decorative panel 1 comprising a substrate 2 made of a thermoplastic material, preferably rigid PVC in the form of the so called SPC and a top layer 3 provided with a printed motif 4, in this case imitating a wood décor. The panel 1 can have the shape of a rectangular and oblong floor panel, with a pair of long sides 5 and a pair of short sides 6. In this case the panel 1 is provided at least at the long sides 5 with coupling means 7 allowing to lock the respective sides 5 together with the sides of a similar panel both in a direction R1 perpendicular to the plane of the coupled panels, as in a direction R2 perpendicular to the coupled sides and in the plane of the coupled panels. As illustrated in FIG. 2 such coupling means or coupling parts can basically have the shape of a tongue 8 and a groove 9, provided with additional cooperating locking means 10 allowing for said locking in the direction R2.

FIG. 5 and FIG. 6 show that the top layer 3 comprises a decorative foil 11 and a wear layer 12 provided on top of the decorative foil 11. The decorative foil 11 comprises a thermoplastic foil 13 for example made of PVC, and the digitally printed décor 4. The decorative foil 11 further comprises an inkjet receiving layer 14. In the example the inkjet receiving layer comprises a binder and a cationic metal salts. The binder preferably comprises water-based dispersion of terpolymer vinyl chloride, vinyl acetate ethylene; water-based dispersion or copolymer vinyl chloride, vinyl acetate; water-based aliphatic PU dispersion; other non-blocking water-based acrylics dispersions. The inkjet receiving layer further comprise a cross linker, a metal salt and other additives like dispersant, coupling agent, wetting agent or PH modifiers.

In the example, the wear layer 12 is a transparent thermoplastic foil, preferably made of PVC.

Between the decorative foil 11 and the wear layer 12 is provided an adhesion layer 15 comprising water-based dispersion of terpolymer vinyl chloride, vinyl acetate ethylene; water-based dispersion or copolymer vinyl chloride, vinyl acetate; water-based aliphatic PU dispersion; other non-blocking water-based acrylics dispersions, thereby strongly improving lamination between the decorative foil and the wear layer.

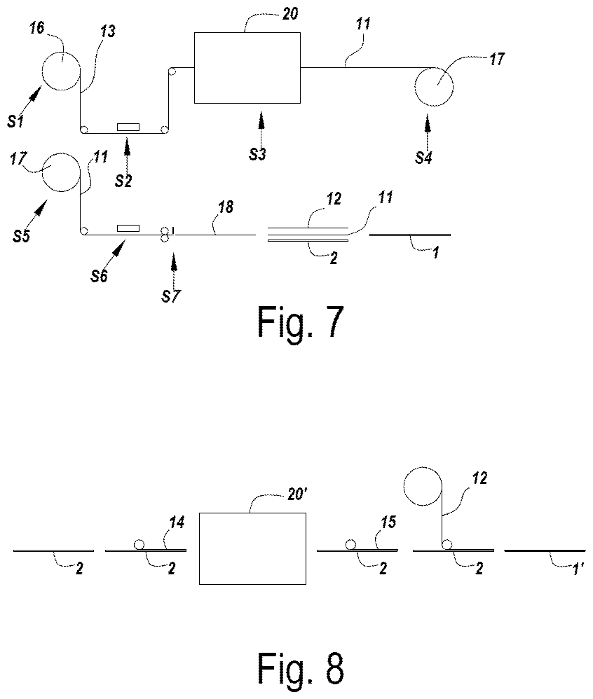

FIG. 7 shows some step of a method for manufacturing the panel 1. In the method is illustrated a step S1 of providing the thermoplastic foil 13 by uncoiling it from a first roll 16. The foil 13 is then provided, on at least one surface, with the inkjet receiving layer 14, for example with a doctor blade or a sprayer, in a step S2.

The coated foil 13 is then printed (step S3) in a single pass printer 20 using pigment containing water-based inks.

After printing, the obtained decorative foil 11 is coiled again in a second roll 17 and then stocked, as indicated in step S4.

For the production of the panel 1, the decorative foil 11 can be uncoiled from second roll 17 in a step S5 and then coated with the adhesion layer 15 in a step S6. The decorative foil 11 can then be cut into sheets 18, in a step S7. The sheets 18 are then sandwiched between a support 2 and a wear layer 12 and then thermally laminated to form the panel 1.

In FIG. 8 it is shown an alternative method for manufacturing a panel 1′ that differs from that of FIG. 4 in that the printed motif is provided directly on the substrate 2 instead of on a foil 13. As a consequence, also the panel 1′ differs from the panel 1 in that the top layer 3 is free from the decorative foil 11, as the décor layer is printed directly on the substrate 2.

In the variant of FIG. 8 a substrate board 2 is firstly coated with the inkjet receiver layer 14, and then printed using a single pass printer 20′ using pigment containing water-based inks.

After printing, the printed substrate 2 is coated with the adhesion layer 15 and then thermal laminated with the wear layer 12.

In the examples the printed motif 4 is obtained by jetting a set of multiple inks. Said set of inks comprises six inks and comprises, preferably is constituted by: cyan, yellow, a first red ink, a second red ink, a first black ink and a second black ink.

Cyan ink comprises a phthalocyanine pigment.

Yellow ink comprises a C.I. pigment yellow 110. Alternative pigments for yellow ink, are C.I. pigment yellow 150, C.I. pigment yellow 93, C.I. pigment yellow 139 or a mixed crystal thereof.

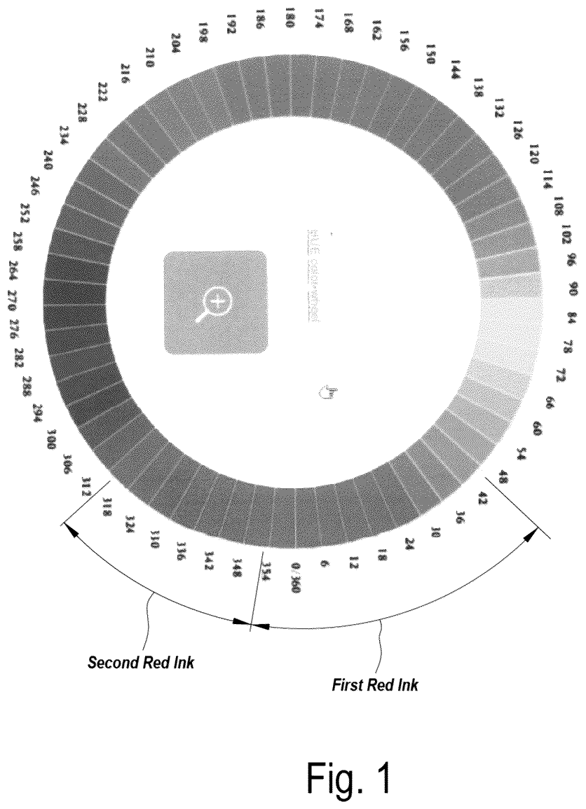

First red ink comprises one warm red pigment having a hue angle between 350° and 42°, in particular C.I. pigment red 254, as shown in FIG. 1.

Said second red ink comprises one warm red pigment having a hue angle between 312° and 350°, in particular C.I. pigment red 254 as shown in FIG. 1.

Both the first and the second black ink comprise carbon black pigment. The first black ink comprises pigment load between 2 and 7% by weight and the second black ink comprises a pigment load between 0.1 and 2% by weight.

Each ink of the set comprises a viscosity below 15 mPas at a temperature between 25 and 45° C.

Each ink of the set comprises a water content between 25 to 80% by weight; 1-20% of polymer resin, preferably PUD resin or acrylic resin; 0.1 to 3% weight of surfynol 104E as wetting agent; a cosolvent in an amount of 2 to 40%, preferably 1,2 propanediol; 0-6% by weight of Dowanol DPnP; 2-40% by weight of 1,2 hexanediol; 1-10% by weight of dispersant; 0.1-1% by weight of pH adjuster.

As it is shown in FIGS. 2 to 3 the use of two black inks provides for a sharper image definition.

It is generally noted that the dimensions of the represented top layer 3 and its components is, in the figures, drawn out of scale in order to better illustrate the invention.

The invention is further disclosed by the following item list as defined by the below numbered items.
1.—A set of inks for inkjet printing on plastic substrate, for example a plastic panel or a plastic foil for being used in laminated panel, preferably floor, wall or furniture panels, said inks being pigmented inks, wherein said set of inks comprises: a cyan ink, a yellow ink, at least a red ink and at least a black ink.
2.—The set of inks of item 1, wherein said set of inks comprises a first red ink and a second red ink wherein said first and second red ink are different each other, for example they comprise different pigments.
3.—The set of inks of item 1 or 2, wherein said first red ink comprises at least one pigment selected in the group consisting of: C.I. pigment red 144, C.I. pigment red 254, C.I. pigment red 176 or mixed crystal thereof; and/or wherein said second red ink comprises at least one pigment selected in the group consisting of: C.I. pigment red 122, C.I. pigment red 202, C.I. pigment violet 19, C.I. pigment red 32 or a mixed crystal thereof.
4.—The set of inks of item 2 or 3, wherein said first red ink comprises at least one pigment having a hue angle between 350° and 42°, for example wherein said first red ink comprises a mixture of pigments and wherein each of said pigments has a hue angle between 350° and 42°.
5.—The set of inks any of items from 2 to 4, wherein said second red ink comprises at least one pigment having a hue angle between 312° and 350°, for example wherein said second red ink comprises a mixture of pigments and wherein each of said pigments has a hue angle between 312° and 350°.
6.—The set of inks according to any preceding items, wherein said red ink comprises a pigment selected in the group consisting of: C.I. pigment red 144, C.I. pigment red 254, C.I. pigment red 176, C.I. pigment red 122, C.I. pigment red 202, C.I. pigment violet 19, C.I. pigment red 32 or a mixed crystal thereof.
7.—The set of inks according to any preceding items, wherein said yellow ink comprises a pigment selected form selected in the group consisting of: C.I. pigment yellow 110, C.I. pigment yellow 150, C.I. pigment yellow 93, C.I. pigment yellow 139 or a mixed crystal thereof.
8.—The set of inks according to any preceding items, wherein the cyan pigment comprises a phthalocyanine pigment.
9.—The set of inks according to any preceding items, wherein said black pigment comprises a carbon black pigment.
10.—The set of inks according to any preceding items, wherein it comprises a first and a second black ink, preferably said second black ink having a lower color intensity than the first black ink.
11.—The set of inks of item 10, wherein said second black ink comprises a pigment load lower than the first black ink, preferably said pigment load of the second black ink is at least 4, more preferably at least 5 times lower than the first black ink.
12.—The set of inks of item 10 or 11, wherein said second black ink comprises a pigment load comprised between 0.1 and 2% based on the total weight of the ink.
13.—The set of inks to any preceding items, wherein said inks are water-based, UV based or hydro-UV based.
14.—A method for manufacturing a printed plastic foil, for being used in laminated panel, preferably floor, wall or furniture panels, comprising the step of providing said plastic foil and the step of inkjet printing a décor on said plastic foil, wherein said step of inkjet printing is performed using the set of inks according to any preceding items.
15.—The method of item 14, wherein the plastic foil is made of a thermoplastic material for example vinyl-based, polyolefins, or polyesters, preferably selected from the group consisting of: polyvinyl chloride (PVC), polyethylene (PE) and polypropylene (PP), polyamides (PA), polyurethane (PU), polystyrene (PS), acrylonitrile-butadiene-styrene (ABS), polymethyl methacrylate (PMMA), polycarbonate (PC), polyethylene terephthalate (PET), polyetheretherketone (PEEK) or mixtures or co-polymers thereof.
16.—The method of item 14 or 15, wherein said décor is a wood, stone, ceramic and/or cement imitating décor.
17.—The method to any of items from 14 to 16, wherein said method comprises the step of applying an ink receiver layer on the surface to be printed of said plastic foil before performing said inkjet printing.
18.—A printed plastic foil for being used in laminated panel, preferably floor, wall or furniture panels, wherein said printed foil comprises an inkjet printed décor that is printed using the set of inks of to any of items from 1 to 13 or manufactured in a method according to any of items from 14 to 17.
19.—A method for manufacturing a printed plastic panel, for being used in laminated panel, preferably floor, wall or furniture panels, comprising the step of providing said plastic panel and the step of inkjet printing a décor directly on said plastic panel, wherein said step of inkjet printing is performed using the set of inks according to any of the times from 1 to 13.
20.—A method for manufacturing a panel, preferably floor, wall or furniture panels, comprising a substrate, preferably made of thermoplastic material, and a top layer, said top layer comprising a décor layer, wherein said décor layer is printed using the set of inks according to any of the times from 1 to 13, preferably said top layer further comprises a wear layer, for example wherein said wear layer is made of thermoplastic material.

1. A set of inks for inkjet printing on a plastic substrate for being used in laminated panel, the inks being pigmented inks, the set of inks comprising:
a cyan ink;
a yellow ink;
a red ink; and
a black ink.

2. The set of inks of claim 1, wherein the red ink comprises a first red ink and a second red ink;
wherein the first red ink and the second red ink are different from each other.

3. The set of inks of claim 2, wherein the first red ink comprises at least one pigment selected from the group consisting of: C.I. pigment red 144, C.I. pigment red 254, C.I. pigment red 176 or mixed crystal thereof; and/or
wherein the second red ink comprises at least one pigment selected from the group consisting of: C.I. pigment red 122, C.I. pigment red 202, C.I. pigment violet 19, C.I. pigment red 32 or a mixed crystal thereof.

4. The set of inks of claim 2, wherein the first red ink comprises at least one pigment having a hue angle between 350° and 42°.

5. The set of inks of claim 2, wherein the second red ink comprises at least one pigment having a hue angle between 312° and 350°.

6. The set of inks of claim 1, wherein the red ink comprises a pigment selected from the group consisting of: C.I. pigment red 144, C.I. pigment red 254, C.I. pigment red 176, C.I. pigment red 122, C.I. pigment red 202, C.I. pigment violet 19, C.I. pigment red 32 or a mixed crystal thereof.

7. The set of inks of claim 1, wherein the yellow ink comprises a pigment selected from the group consisting of: C.I. pigment yellow 110, C.I. pigment yellow 150, C.I. pigment yellow 93, C.I. pigment yellow 139 or a mixed crystal thereof.

8. The set of inks of claim 1, wherein the cyan ink comprises a phthalocyanine pigment.

9. The set of inks of claim 1, wherein the black ink comprises a carbon black pigment.

10. The set of inks of claim 1, wherein the black ink comprises a first black ink and a second black ink.

11. The set of inks of claim 10, wherein the second black ink comprises a pigment load lower than the first black ink.

12. The set of inks of claim 10, wherein the second black ink comprises a pigment load of between 0.1 and 2% based on a total weight of the second black ink.

13. The set of inks of claim 1, wherein the inks are water-based, UV based or hydro-UV based.

14. A method for manufacturing a printed plastic foil, for being used in laminated panel, the method comprising:
providing the plastic foil; and
inkjet printing a décor on the plastic foil;
wherein the inkjet printing is performed using the set of inks according to claim 1.

15. The method of claim 14, wherein the plastic foil is fabricated from a thermoplastic material.

16. The method of claim 14, wherein the décor is a wood, stone, ceramic and/or cement imitating décor.

17. The method of claim 14, wherein the method comprises:
applying an ink receiver layer on a surface to be printed of the plastic foil before performing the inkjet printing.

18. A printed plastic foil for being used in laminated panel, wherein the printed foil comprises an inkjet printed décor that is printed using the set of claim 1.

19. A method for manufacturing a printed plastic panel, for being used in laminated panel, the method comprising:
providing the plastic panel; and
inkjet printing a décor directly on the plastic panel;
wherein the inkjet printing is performed using the set of inks of claim 1.

20. A method for manufacturing a panel having a substrate and a top layer, the top layer including a décor layer, the method comprising:
printing the décor layer using the set of inks according to claim 1.
